(19) United States
(12) Patent Application Publication
(10) Pub. No.: US 2018/0130399 A1
(43) Pub. Date: May 10, 2018

(54) SENSOR-EQUIPPED DISPLAY DEVICE, CONTROL DEVICE, AND CONTROL METHOD

(71) Applicant: SHARP KABUSHIKI KAISHA, Sakai City, Osaka (JP)

(72) Inventors: MASASHI MAYUMI, Sakai City (JP); ATSUSHI OKADA, Sakai City (JP)

(21) Appl. No.: 15/573,709

(22) PCT Filed: May 10, 2016
(86) PCT No.: PCT/JP2016/063884

§ 371 Date: Nov. 13, 2017

(30) Foreign Application Priority Data
May 14, 2015 (JP) 2015-098808

(51) Int. Cl. G09G 3/20; G09G 3/02

(52) U.S. Cl. CPC G09G 3/2018; G09G 3/025

(57) ABSTRACT

A sensor-equipped display device is provided in which respective periods of time for the driving for display and the driving for detecting an object are ensured, while the mutual interference therebetween is suppressed. The sensor-equipped display device includes a scanning driving unit (4) that repeats a scanning operation of sequentially selecting a plurality of display scanning lines (G) in a first direction, and a data driving unit (5) that applies voltages to a plurality of data lines (S). Further, the sensor-equipped display device includes a detection control unit (30) that repeats a scanning operation of sequentially driving a plurality of detection scanning lines (DRL) in the first direction, and detects signals of detection lines (SNL). Between start of one screen scanning operation with respect to the detection scanning lines (G) and end of the same, a screen scanning operation with respect to the display scanning lines (DRL) starts, and time for scanning one screen with respect to detection scanning lines (DRL) is equal to, or shorter than, time for scanning one screen with respect to the display scanning lines (G).

### TECHNICAL FIELD

The disclosure of the present application relates to a sensor-equipped display device that includes a screen that displays an image, and a sensor that detects contact or approach of an object with respect to the screen.

### BACKGROUND ART

In recent years, a sensor-equipped display device that includes a display unit including a screen that displays an image, and a touch panel that detects contact or approach of an object such as a finger or a pen with respect to the screen has been commercialized. In the sensor-equipped display device, driving signals for the display unit can be noise and exert influences on the touch panel. Besides, the driving signals for the touch panel also can be noise for the display unit. The display unit and the touch panel can interfere with each other in this way, which causes the respective signal-noise (SN) ratios to decrease, resulting in that malfunctions occur, or the detection accuracy or the display quality deteriorate, in some cases.

In order to suppress the interference between the display unit and the touch panel, the controlling is performed with the driving timing of the display unit and the driving timing of the touch panel being associated with each other. For example, in the display device having a touch detection function disclosed in Patent Document 1 indicated below, the display elements are driven in such a manner that M horizontal lines are sequentially displayed in each of a plurality of unit driving periods that compose one frame period. Further, touch detection elements are driven during N touch detection periods provided in the unit driving period, N being smaller than M.

In this way, one frame period is divided into a driving period assigned for display and a diving period assigned for detection on the touch panel, and the driving for display and the driving for detection are executed sequentially, whereby interference with each other can be suppressed.

### PRIOR ART DOCUMENT

### Patent Document

Patent Document 1: JP-A-2013-84168

### SUMMARY OF THE INVENTION

### Problem to be Solved by the Invention

If the resolution of the display unit is increased, the driving time of the display unit increases. If the driving time of the display unit increases, the driving period that can be assigned for the touch panel decreases, which makes it difficult to balance the driving of the display unit and the driving of the touch panel well. Besides, if a sufficient period for driving the touch panel cannot be ensured, this can deter the performance of the touch panel from improving.

The present application discloses a sensor-equipped touch panel, a control device, and a control method in which the interference between the driving for display and the driving for detecting an object can be suppressed, and respective driving periods can be ensured.

### Means to Solve the Problem

A sensor-equipped display device in one embodiment of the present invention relates to a sensor-equipped display device that includes a screen that displays an image, and a sensor that detects contact or approach of an object with respect to the screen. The sensor-equipped display device includes: a plurality of display scanning lines that are arrayed in a first direction; a plurality of data lines that are arrayed in a second direction that is different from the first direction; a plurality of switching elements that are provided in correspondence to points of intersection between the display scanning lines and the data lines, respectively; and a plurality of pixel electrodes that are connected to the switching elements, respectively.

Further, the sensor-equipped display device includes: a scanning driving unit that repeats a screen scanning operation with respect to the display scanning lines, the screen scanning operation with respect to the display scanning lines being an operation of selecting the display scanning lines sequentially in the first direction throughout the screen; and a data driving unit that outputs a signal to the data lines in synchronization with the scanning of the display scanning lines by the scanning driving unit, thereby applying, to the pixel electrodes, voltages corresponding to gray levels to be displayed, respectively.

Still further, the sensor-equipped display device includes: a plurality of detection scanning lines that are arrayed in the first direction; a plurality of detection lines that are arrayed in the second direction; and a detection control unit that repeats a screen scanning operation with respect to the detection scanning lines, the screen scanning operation with respect to the detection scanning lines being an operation of driving the detection scanning lines sequentially in the first direction throughout the screen, thereby detecting signals of the detection lines in synchronization with the driving of the detection scanning lines, respectively. Between start of a current one of the screen scanning operation with respect to the detection scanning lines and end of the same, a current one of the screen scanning operation with respect to the display scanning lines starts, and time for scanning one screen with respect to the detection scanning lines is equal to, or shorter than, time for scanning one screen with respect to the display scanning lines.

### Effect of the Invention

According to the disclosure of the present application, in the sensor-equipped display device, the mutual interference between the driving for display and the driving for detecting an object can be suppressed, and respective driving periods can be ensured.

### BRIEF DESCRIPTION OF DRAWINGS

FIG. 1 is a block diagram illustrating an exemplary configuration of a sensor-equipped display device.

FIG. 2 is a cross-sectional view illustrating the exemplary configuration of the sensor-equipped display device illustrated in FIG. 1.

FIG. 3 is a perspective view illustrating an exemplary laminate configuration of drive lines, detection lines, gate lines G, and data lines.

FIG. 4 illustrates exemplary waveforms of driving signals of the display device and the detection device.

FIG. 5 illustrates exemplary transition of the location where the gate line is driven and the location where the drive line is driven, on the screen.

FIG. 6 is a graph for explaining the relationship between the progress of the scanning of the gate lines and that of the drive lines.

FIG. 7 is a graph for explaining the difference between the screen scanning rate and starting time with respect to the gate lines and those with respect to the drive lines.

FIG. 8 illustrates modification examples of the waveforms of the driving signals of the display device and the detection device.

FIG. 9 illustrates exemplary transition of the location where the gate line is driven and the location where the drive line is driven, on the screen.

FIG. 10 is a graph for explaining the relationship between the progress of the scanning of the gate lines and that of the drive lines.

FIG. 11 is a functional block diagram illustrating an exemplary configuration of a TP controller.

### MODE FOR CARRYING OUT THE INVENTION

A sensor-equipped display device in one embodiment of the present invention relates to a sensor-equipped display device that includes a screen that displays an image, and a sensor that detects contact or approach of an object with respect to the screen. The sensor-equipped display device includes: a plurality of display scanning lines that are arrayed in a first direction; a plurality of data lines that are arrayed in a second direction that is different from the first direction; a plurality of switching elements that are provided in correspondence to points of intersection between the display scanning lines and the data lines, respectively; and a plurality of pixel electrodes that are connected to the switching elements, respectively.

Further, the sensor-equipped display device includes: a scanning driving unit that repeats a screen scanning operation with respect to the display scanning lines, the screen scanning operation with respect to the display scanning lines being an operation of selecting the display scanning lines sequentially in the first direction throughout the screen; and a data driving unit that outputs a signal to the data lines in synchronization with the scanning of the display scanning lines by the scanning driving unit, thereby applying, to the pixel electrodes, voltages corresponding to gray levels to be displayed, respectively.

Still further, the sensor-equipped display device includes: a plurality of detection scanning lines that are arrayed in the first direction; a plurality of detection lines that are arrayed in the second direction; and a detection control unit that repeats a screen scanning operation with respect to the detection scanning lines, the screen scanning operation with respect to the detection scanning lines being an operation of driving the detection scanning lines sequentially in the first direction throughout the screen, thereby detecting signals of the detection lines in synchronization with the driving of the detection scanning lines, respectively. Between start of a current one of the screen scanning operation with respect to the detection scanning lines and end of the same, a current one of the screen scanning operation with respect to the display scanning lines starts, and time for scanning one screen with respect to the detection scanning lines is equal to, or shorter than, time for scanning one screen with respect to the display scanning lines.

According to the above-described configuration, at the point in time when the screen scanning operation with respect to the display scanning lines starts, the screen scanning operation with respect to the detection scanning lines has already started. Therefore, the location on the screen of the selected display scanning line, and the location on the screen of the detection scanning line that is driven at the same time are different as viewed in the first direction. Further, the time required for scanning one screen with respect to the detection scanning lines is shorter than the time required for scanning one screen with respect to the display scanning lines, and therefore, in the screen scanning operation with respect to the display scanning lines, the location of the selected display scanning line does not overlap, or less possibly overlaps, the location of the detection scanning line that is driven at the same time. In other words, the scanning with respect to the display scanning lines and the scanning with respect to the detection scanning lines are executed at different locations on the screen simultaneously. This allows the driving of the display scanning lines and the driving of the detection scanning lines to be executed simultaneously, in a state in which they hardly interfere with each other. As a result, the interference between the driving for display and the driving for detecting an object can be suppressed, and respective driving periods can be ensured.

The configuration can be such that the start of the current one of the screen scanning operation with respect to the detection scanning lines is before the start of the current one of the screen scanning operation with respect to the display scanning lines, and before end of a preceding one of the screen scanning operation with respect to the display scanning lines. In other words, in the screen scanning operation with respect to the detection scanning lines, which is repeated a plurality of times, may include one operation that has started before start of a current one of the screen scanning operation with respect to the display scanning lines, and before end of a preceding one of the screen scanning operation with respect to the display scanning lines. This makes it possible to elongate time that can be assigned for the screen scanning operation with respect to the detection scanning lines, thereby ensuring time for driving for detection.

The configuration can be such that the time for scanning one screen with respect to the detection scanning lines is equal to, or less than, half of the time for scanning one screen with respect to the display scanning lines. This makes it possible to further suppress the interference between the driving of the display scanning lines and the driving of the detection scanning lines.

The configuration may be such that a cycle of the screen scanning operation with respect to the detection scanning lines is different from a cycle of the screen scanning operation with respect to the display scanning lines. This makes it possible to increase the degree of freedom in design for the driving for detection.

The configuration can be such that the cycle of the screen scanning operation with respect to the detection scanning lines is half of the cycle of the screen scanning operation with respect to the display scanning lines, and that in a period from end of the current one the screen scanning operation with respect to the display scanning lines until start of a next one of the screen scanning operation with respect to the display scanning lines, the current one of the screen scanning operation with respect to the detection scanning lines ends, and a next one of the screen scanning operation with respect to the detection scanning lines starts. This allows the screen scanning operation with respect to the detection scanning lines to be performed at a rate (frequency) of twice the rate of the screen scanning operation with respect to the display scanning lines. Further, this also makes it possible to execute the scanning of the detection scanning lines and the scanning of the display scanning lines simultaneously in such a manner that the location of the display scanning line selected in the scanning, and the location of the detection scanning line driven at the same time should not overlap each other.

The configuration can be such that the detection control unit starts the screen scanning operation with respect to the detection scanning lines, according to a signal generated based on a synchronization signal for controlling a timing of the screen scanning operation with respect to the display scanning lines by the scanning driving unit. This makes it easy to control the timing for starting the screen scanning operation with respect to the detection scanning lines, based on the timing for starting the screen scanning operation with respect to the display scanning lines.

The configuration can be such that the detection control unit controls a timing for starting the screen scanning operation with respect to the detection scanning lines, based on the synchronization signal for controlling a timing for starting the screen scanning operation with respect to the display scanning lines by the scanning diving unit, and the detection control unit controls respective timings for driving the detection scanning lines, based on a horizontal synchronization signal for controlling respective timings for driving the display scanning lines.

This makes it easier to control the timing for starting the scanning operation with respect to the detection scanning lines based on the timing for starting the scanning operation with respect to the display scanning lines, and to control the timing for driving each detection scanning line based on the timing for driving each display scanning line.

The sensor-equipped display device can further include: a first substrate on which the display scanning lines, the data lines, and the switching elements are arranged; a second substrate provided so as to be opposed to the first substrate; and a common electrode provided so as to be opposed to the pixel electrodes. In this case, the detection scanning lines and the detection lines are arranged on at least one of the first substrate and the second substrate, and are provided independently from the common electrode.

By arranging the detection scanning lines and the detection lines for detection on at least one of the first substrate, on which the display scanning lines, the data lines, and the switching elements for display are arranged, and the second substrate opposed to the first substrate, the display unit and the sensor can be formed integrally by using the first substrate and the second substrate. Further, by providing the detection scanning lines and the detection lines independently from the common electrode opposed to the pixel electrodes, the driving of the detection scanning lines and the driving of the display scanning lines hardly restrict each other. This therefore increases the degree of freedom in design for the driving method.

A control device in an embodiment of the present invention relates to a control device that controls electronic equipment that includes: a screen having a plurality of pixels; and a sensor that detects contact or approach of an object with respect to the screen. The control device includes: a signal acquisition unit that receives a synchronization signal for controlling a timing for starting update of display on the screen; a signal generation unit that generates a signal for controlling a timing of a detection scanning operation with respect to the screen for detecting contact or approach of the object, based on the synchronization signal; and an output unit that outputs the signal generated by the signal generation unit, or a diving signal for the sensor based on the signal generated by the signal generation unit. The signal generation unit generates the signal so that the update of display on the screen starts between start of the detection scanning operation with respect to the screen and end of the same, and a scanning time for one screen of the detection scanning operation is equal to or shorter than a display update time for one screen.

According to the above-described configuration, at the point in time when the update of display starts, the detection scanning operation has started. A location at which the update of display is being executed on the screen, and a location at which the detection scanning operation is being executed, are different. Further, since a time required for the detection scanning operation over one screen is equal to or shorter than time required for updating display for one screen, a location at which the update of display is being executed, in the update of display for one screen, does not overlap or less possibly overlaps a location at which the detection scanning operation is being executed. In other words, the update of display and the detection scanning operation are executed simultaneously at different locations on the screen, respectively. The update of display, and the scanning for detection, therefore can be executed simultaneously, in a state in which these hardly interfere with each other. As a result, it is possible to ensure respective periods of time for the driving for display and the driving for detecting an object, while suppressing the mutual interference therebetween.

A control method in an embodiment of the present invention relates to a control method for controlling electronic equipment that includes: a screen having a plurality of pixels; and a sensor that detects contact or approach of an object with respect to the screen. The control method includes: a display controlling step of controlling a timing for starting update of display on the screen, based on a synchronization signal; and a detection controlling step of controlling a detection scanning operation with respect to the screen for detecting the contact or approach of the object, based on the synchronization signal for controlling the timing for starting the update of display on the screen. In the detection controlling step, the detection scanning operation is controlled so that the update of display on the screen starts between start of the detection scanning operation with respect to the screen and end of the same, and a scanning time for one screen of the detection scanning operation is equal to or shorter than a display update time for one screen.

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of part of constituent members is omitted. Further, the dimension ratios of the constituent members illustrated in the drawings do not necessarily indicate the real dimension ratios.

### Embodiment 1

### Exemplary Configuration of Sensor-Equipped Display Device

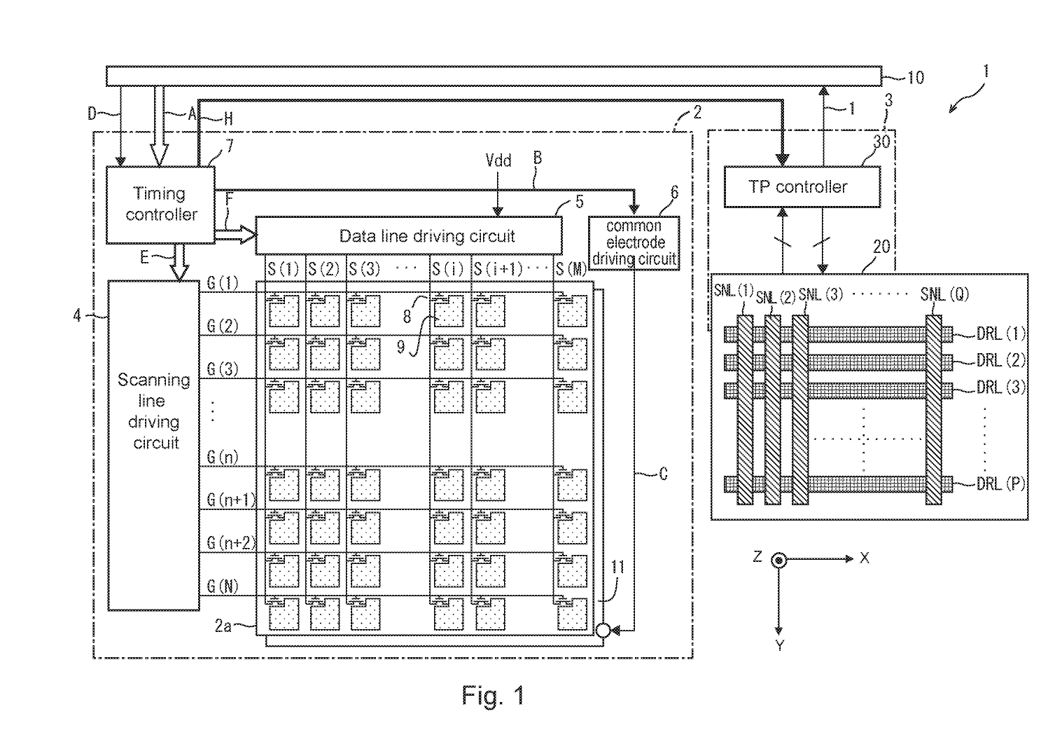

FIG. 1 is a block diagram illustrating an exemplary configuration of a sensor-equipped display device in Embodiment 1. The sensor-equipped display device 1 illustrated in FIG. 1 is electronic equipment that includes a screen that displays an image, and a sensor that detects contact or approach of an object with respect to the screen. The sensor-equipped display device 1 includes a display device 2, a detection device 3, and a system-side controller 10.

### Exemplary Configuration of Display Device

The display device 2 has a plurality of gate lines G (G(1), G(2), . . . , G(n), . . . , G(N)) and a plurality of data lines S (S(1), S(2), . . . , S(i), . . . S(M)), which are arranged in a display region 2a, which corresponds to the screen that displays an image. The gate lines G are exemplary display scanning lines, and are arrayed in a first direction (the Y direction in the example illustrated in FIG. 1). The data lines S are arrayed in a second direction that is different from the first direction (the X direction that intersects with the Y direction at right angles in the example illustrated in FIG. 1).

At positions corresponding to the points of intersection of the gate lines G and the data lines S, thin film transistors (TFTs) 8 are provided. Each TFT 8 is connected to the gate line G and the data line S. Further, to each TFT 8, a pixel electrode 9 is connected. The TFT 8 is an exemplary switching element. The TFT 8 is switched ON/OFF according to a signal of the gate line G. When the TFT 8 is ON, a signal of the data line S is input to the pixel electrode 9. This causes a voltage corresponding to a gray level to be displayed at the pixel is applied to the pixel electrode 9.

In the display region 2a, one pixel is arranged in an area surrounded by two adjacent gate lines G and two adjacent data lines S. In the display region 2a, a plurality of pixels are arranged in matrix. Each pixel includes the TFT 8 and the pixel electrode 9. The area where the pixels are arranged is the display region 2a, that is, the screen. Further, a common electrode 11 is provided at a position opposed to the plurality of pixel electrodes 9.

The display device 2 further includes a timing controller 7, a scanning line driving circuit (gate driver) 4, a data line driving circuit (source driver) 5, and a common electrode driving circuit 6. The timing controller 7 is connected to the system-side controller 10, the scanning line driving circuit 4, the data line driving circuit 5, and the common electrode driving circuit 6. The scanning line driving circuit 4 is connected to the gate lines G. The data line driving circuit 5 is connected to the data lines S. The common electrode driving circuit 6 is connected to the common electrode 11.

The timing controller 7 receives a video signal (as indicated by arrow A) and a synchronization signal (as indicated by arrow D) from the system-side controller 10. The timing controller 7 outputs a video signal to the data line driving circuit 5 (as indicated by arrow F). Based on a synchronization signal D, to the scanning line driving circuit 4, the data line driving circuit 5, and the common electrode driving circuit 6, the timing controller 7 outputs a signal that serves as a reference signal that these circuits refer to when the circuits operate in synchronization with one another, that is, a signal for controlling an operation timing (as indicated by arrows E, F, B).

The synchronization signal D includes, for example, a vertical synchronization signal and a horizontal synchronization signal. The vertical synchronization signal can be a signal that indicates the timing for scanning the screen, that is, the timing for updating the display on the screen. The horizontal synchronization signal can be a signal that indicates the timing for displaying the pixels in each row on the screen.

As one example, the timing controller 7 outputs a gate startpulse signal and a gate clock signal based on the vertical synchronization signal and the horizontal synchronization signal, to the scanning line driving circuit 4 (as indicated by arrow E). The gate startpulse signal can include, for example, a pulse that is generated at a timing corresponding to a timing at which a pulse of the vertical synchronization signal is generated. The gate clock signal can include a pulse that is generated at a timing corresponding to a timing at which a pulse of the horizontal synchronization signal is generated.

The timing controller 7 outputs a source startpulse signal, a source latch strobe signal, and a source clock signal based on the vertical synchronization signal and the horizontal synchronization signal, to the data line driving circuit 5 (as indicated by arrow F).

The scanning line driving circuit 4 supplies a signal indicating an image to be displayed, to each data line S. The scanning line driving circuit 4 repeats a scanning operation of selecting the gate lines G in one screen sequentially in the first direction (the Y direction), at cycles indicated by the vertical synchronization signal. More specifically, the scanning line driving circuit 4 starts an operation of scanning one screen according to the gate startpulse signal, and applies a selection signal to the gate lines G sequentially according to the gate clock signal.

The operation of scanning one screen may be carried out by the progressive method in which all the gate lines G(1) to G(N) in one screen are sequentially selected, or alternatively, by the interlace method in which the gate lines are selected with a part of the same being skipped, for example, every other gate lines G are selected.

The data line driving circuit 5 outputs a signal based on a video signal to the data lines S, in synchronization with the scanning of the gate lines G by the scanning line driving circuit 4. With this, a voltage according to an image to be displayed can be applied to the pixel electrode 11. In other words, a voltage according to a gray level to be displayed is applied to each pixel electrode. More specifically, the data line driving circuit 5 sequentially holds, in a register, a digital video signal indicating a voltage to be applied to each data line, at a timing at which the pulse of the source clock signal is generated. The digital video signal thus held is converted into an analog voltage, at a timing at which the pulse of the source latch strobe signal is generated. The analog voltage thus obtained by conversion is applied to the plurality of data lines S at once, as a video signal for driving.

The common electrode driving circuit 6 applies a predetermined voltage to the common electrode 11, based on the signal received from the timing controller 7 (as indicated by arrow C).

As is described above, at a timing at which the selection signal is applied to each gate line, the video signal for diving is applied to the data line S, and further, a predetermined voltage is applied to the common electrode 11, whereby an image is displayed on the display region 2a, that is, on the screen.

### Exemplary Configuration of Detection Device

The detection device 3 is an exemplary sensor that detects contact or approach of an object such as a finger or a pen with respect to the screen of the display device 1. The detection device 3 includes a touch panel 20 and a touch panel controller (hereinafter referred to as a “TP controller”) 30.

The touch panel 20 includes a plurality of drive lines DRL (DRL(1) to DRL(P)) arrayed in the first direction (in the Y direction in the example illustrated in FIG. 1), and a plurality of detection lines SNL (SNL(1) to SNL(Q)) arrayed in the second direction (in the X direction intersecting with the Y direction at right angles in this example). The drive lines DRL are electrodes extending in the second direction (the X direction). The detection lines SNL are electrodes extending in the first direction (the Y direction). The drive lines DRL are exemplary detection scanning lines.

In FIG. 1, for the sake of explanation, the touch panel 20 and the display region 2a of the display device 2 are drawn at positions that do not overlap in the Z direction, but actually, the touch panel 20 is arranged at a position that overlaps the display region 2a of the display device 2 when viewed in the direction vertical to the screen. In other words, the drive lines DRL and the detection lines SNL are arranged so as to be superposed on the screen, which is the display region 2a. Further, the drive lines DRL are arranged so as to be arrayed in the same direction as the direction in which the gate lines G are arrayed (in the Y direction in the present example). The detection lines SNL are arranged so as to be arrayed in the same direction as the direction in which the data lines S are arrayed (in the X direction in the present example).

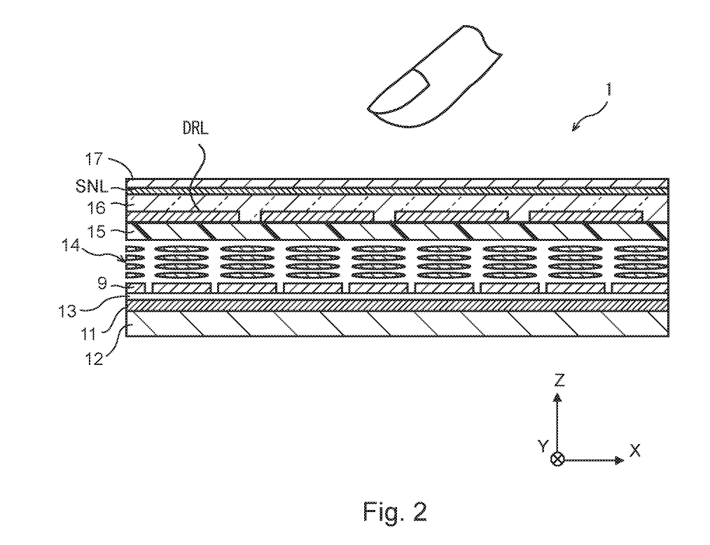

FIG. 2 is a cross-sectional view illustrating an exemplary configuration of the sensor-equipped display device 1 illustrated in FIG. 1. In the example illustrated in FIG. 2, the sensor-equipped display device 1 includes a first substrate 12 and a second substrate 16 that are opposed to each other. Between the first substrate 12 and the second substrate 16, a liquid crystal layer 14 is provided.

On a surface of the first substrate 12 opposed to the second substrate 16, a common electrode 11 and pixel electrodes 9 are provided. The common electrode 11 is provided at a position opposed to the plurality of pixel electrodes 9, with an insulating layer 13 being interposed therebetween. Further, the gate lines G, the data lines S, and the TFTs 8 are arranged on the first substrate 12, though these are not illustrated.

On a surface of the second substrate 16 opposed to the first substrate 12, a color filter 15 and the drive lines DRL are arranged. On another surface of the second substrate 16, on a side opposite to the first substrate 12 side, the detection lines SNL and a polarizing plate 17 are arranged. In the present example, the display device 2 and the detection device 3 are integrally formed with the first substrate 12 and the second substrate 16. Both of the drive lines DRL and the detection lines SNL are provided independently from the common electrode 11. In other words, the configuration is not such that the common electrode 11 of the display device 2 doubles as the drive lines DRL or the detection lines SNL of the touch panel 20. This makes the driving of the touch panel 20 less restricted by the driving of the display device 2.

The first substrate 12 and the second substrate 16 can be formed with, for example, glass or resin. The pixel electrodes 9, the common electrode 11, the detection lines SNL, and the drive lines DRL can be formed with, for example, transparent electrodes such as electrodes made of indium tin oxide (ITO) or the like.

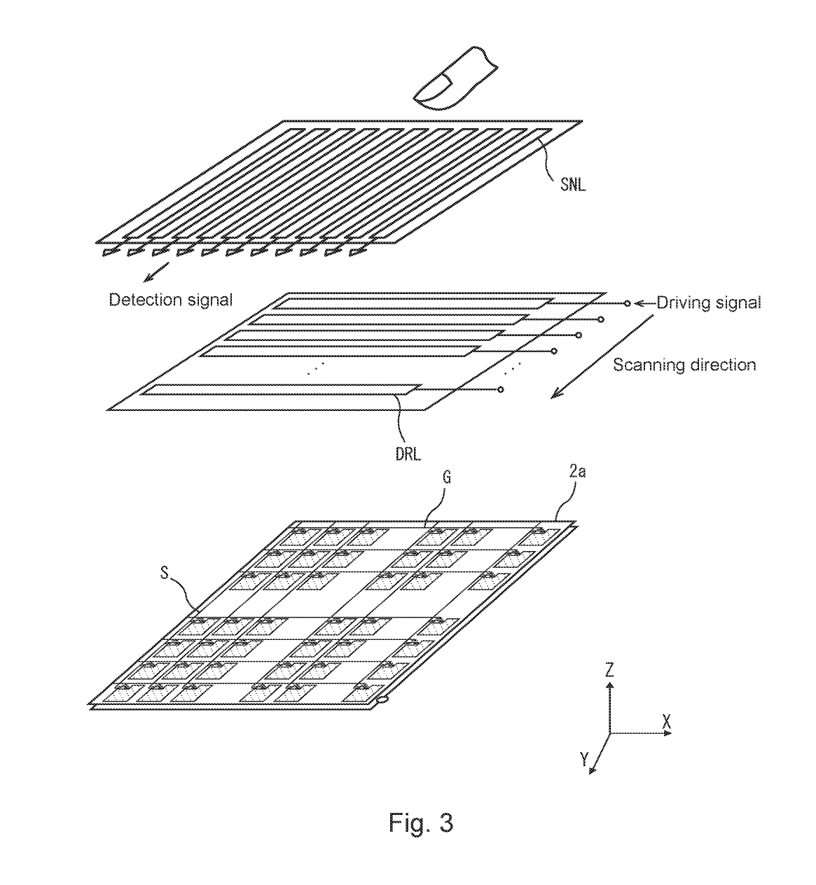

FIG. 3 is a perspective view illustrating an exemplary laminate structure of the drive lines DRL, the detection lines SNL, the gate lines G, and the data lines S. In the example illustrated in FIG. 3, the layer of the gate lines G, the layer of the data lines S, the layer of the drive lines DRL, and the layer of the detection lines SNL, are laminated in the Z direction. Capacitors are formed between the drive lines DRL and the detection lines SNL. The capacitance at a position corresponding to each point of intersection between the drive lines DRL and the detection lines SNL changes depending on the approach or contact of an object. The matrix formed by the drive lines DRL and the detection lines SNL is arranged so as to overlap the entirety of the display region 2a. This means that the drive lines DRL and the detection lines SNL are arranged in an area overlapping an area where the gate lines G and the data lines S are provided.

In the example illustrated in FIG. 3, the gate lines G and the drive lines DRL are arranged so as to be parallel to each other. The gate lines G and the drive lines DRL do not have to be completely parallel. For example, the direction of the gate lines G and the direction of the drive lines DRL may be slightly different. The drive lines DRL may include some parts that are not parallel with the gate lines G.

To the drive lines DRL, a driving signal is input sequentially. To the detection lines SNL, response signals in response to the driving signal are output as detection signals. The detection signals contain information with regard to capacitances at positions corresponding to the points of intersection between the drive lines DRL and the detection lines SNL.

For example, the TP controller 30 repeats a scanning operation of sequentially applying a driving signal to the drive lines DRL in the first direction (the Y direction), and in response to the driving of the drive lines DRL, detects respective detection signals of the detection lines SNL. During respective periods while the drive lines DRL are driven, the TP controller 30 detects respective signals of the detection lines SNL. In the detected signals, changes in the capacitances around the drive lines DRL and the detection lines SNL are reflected. In other words, changes in the capacitances in the display region 2a (the screen) are detected as the detection signals of the detection lines SNL. The TP controller 30 is capable of computing the position of contact or approach of an object with respect to the screen, based on the signals detected from the detection lines SNL.

The exemplary laminate structure of the gate lines G, the data lines S, the drive lines DRL, and the detection lines SNL is not limited to the example illustrated in FIGS. 2 and 3. For example, the order of lamination of the drive lines DRL and the detection lines SNL may be in the reverse order. Further, the drive lines DRL and the detection lines SNL can be formed in the same layer. Still further, the substrate on which the drive lines DRL and the detection lines SNL are formed is not limited to the second substrate 16, but the drive lines DRL and the detection lines SNL can be arranged on the first substrate 12, or can be arranged dispersedly on both of the first substrate 12 and the second substrate 16.

FIG. 1 is referred to again. The TP controller 30 can control the timing of the screen scanning operation with respect to the drive lines DRL in the touch panel 20, based on a synchronization signal received from the timing controller 7. More specifically, the TP controller 30 starts the screen scanning operation with respect to the drive lines DRL before the screen scanning operation with respect to the gate lines G starts. Further, time for scanning one screen with respect to the drive lines DRL is controlled so as to be equal to or shorter than time for scanning one screen with respect to the gate lines G.

Here, “time for scanning one screen” is time necessary for performing a single screen scanning operation. For example, a time required for scanning all of the drive lines DRL or the gate lines G to be scanned in a single screen scanning operation is assumed to be “time for scanning one screen”. On the other hand, a cycle of the screen scanning operation is a period of time from the start of a current one of the screen scanning operation until the start of a next one of the screen scanning operation. The time for scanning one screen, therefore, is not necessarily equal to the cycle of the screen scanning operation.

The TP controller 30 can generate a signal for controlling timings for driving the drive lines DRL, based on a synchronization signal for controlling timings for scanning the gate lines G. For example, based on the timings at which the pulses of the vertical synchronization signal received from the timing controller 7 are generated, the TP controller 30 can generate a signal indicating a timing for starting the screen scanning operation with respect to the drive lines DRL.

As one example, the TP controller 30 can generate a trigger signal that causes a pulse to be generated at a point in time that is advanced/delayed for a certain period of time from the point in time when the pulse of the vertical synchronization signal is generated. The TP controller 30 causes the screen scanning operation with respect to the drive lines DRL at a timing when the pulse of the trigger signal is generated. This allows the screen scanning operation with respect to the drive lines DRL to start at a point in time that is advanced/delayed for a certain period of time from the point in time when the screen scanning operation with respect to the gate lines starts. Or alternatively, in response to the generation of a pulse of the trigger signal, a startpulse signal that causes a pulse to be generated at a predetermined cycle may be generated, so that this is used as a signal that instructs the start of the screen scanning operation with respect to the drive lines DRL. By controlling the start of the screen scanning operation with respect to the drive lines DRL in this way by using the trigger signal that indicates the timing advanced/delayed from the pulse of the vertical synchronization signal, the screen scanning operation with respect to the drive lines DRL can start before the screen scanning operation with respect to the gate lines starts.

A driving signal applied to one drive line DRL can include, for example, a plurality of pulses generated at a predetermined frequency. By controlling the number of such pulses and frequencies thereof, the time for scanning the drive lines DRL in one screen can be controlled. The TP controller 30 can set the number of pulses of the driving signal and the frequency thereof, by using, for example, a value preliminarily recorded in a register (not shown) or the like. Or alternatively, the TP controller 30 can control the frequency of the pulse of the diving signal, by using the synchronization signal used for driving the display device 1.

For example, the TP controller 30 can control the timings of the pulses to be applied to each drive line DRL, based on the horizontal synchronization signal received from the timing controller 7. As a specific example, a signal that includes a pulse that is generated at the same cycle as the cycle at which the pulse of the horizontal synchronization signal is generated, and that is generated at timings advanced/delayed for a certain period of time from the timings at which the pulse of the horizontal synchronization signal is generated, can be used as a driving signal for each drive line DRL. This makes it possible to drive the drive lines DRL at timings advanced/delayed from the timings of application of the signals to the data lines S.

### Operation Example of Detection Device

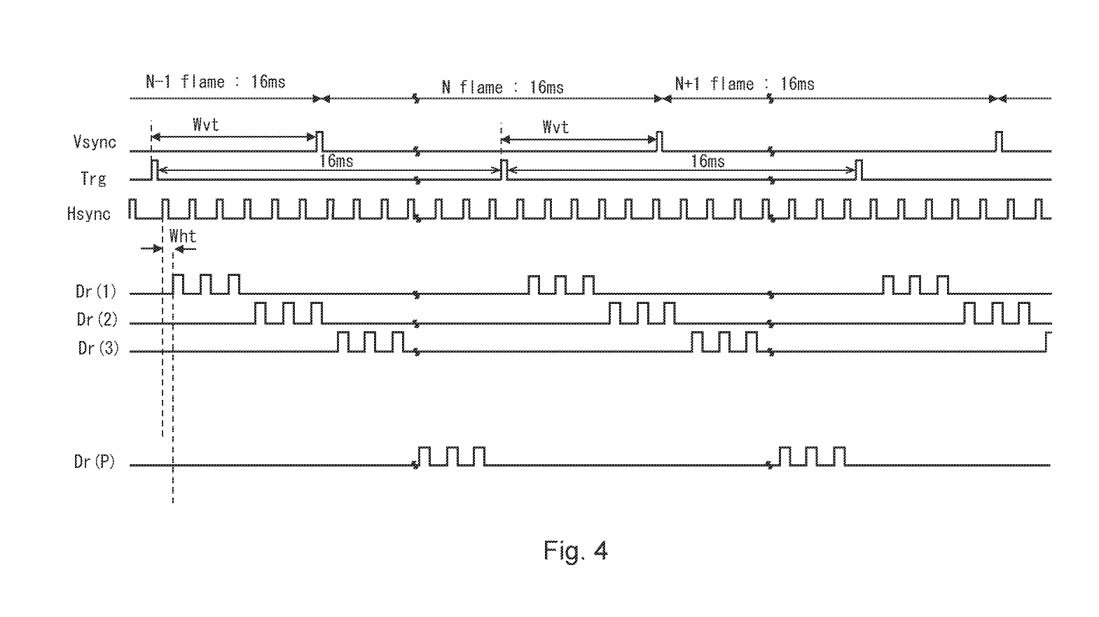

FIG. 4 illustrates exemplary waveforms of driving signals in the display device 2 and the detection device 3. In the example illustrated in FIG. 4, the timing for driving the display device 2 is controlled according to a vertical synchronization signal Vsync and a horizontal synchronization signal Hsync in which pulses are generated at a certain set cycle.

The pulse interval of the vertical synchronization signal Vsync is one frame period. During one frame period, the gate lines G in one screen are scanned. For example, the pulse of the vertical synchronization signal Vsync serves as a trigger for the start of the screen scanning operation with respect to the gate lines G. The horizontal synchronization signal Hsync controls the timing for writing with respect to the pixels in each row. For example, at a timing when a pulse of the horizontal synchronization signal Hsync is generated, the selection signal is applied to one of the gate lines G, and video signals are applied to a plurality of the data lines S at once.

The TP controller 30 can grasp the timing at which the screen scanning operation with respect to the gate lines G starts, with use of the vertical synchronization signal Vsync. Further, the TP controller 30 can grasp the timing at which each gate line is selected and signals are input to the data lines S, that is, the writing timing, with use of the horizontal synchronization signal Hsync. The TP controller 30 can receive the vertical synchronization signal Vsync and the horizontal synchronization signal Hsync, for example, from the timing controller 7 or the system-side controller 10.

The trigger signal Trg is a signal generated by the TP controller 30 based on the vertical synchronization signal Vsync and the horizontal synchronization signal Hsync. The trigger signal Trg controls the timing for starting the screen scanning operation with respect to the drive lines DRL of the touch panel.

In the example illustrated in FIG. 4, the cycle (frequency) of the pulse of the trigger signal Trg is identical to that of the vertical synchronization signal Vsync (16 ms). The pulse of the trigger signal Trg is generated at a timing advanced for a certain period (Wvt) from the pulse of the vertical synchronization signal Vsync. The TP controller 30 can preliminarily set the period Wvt between the pulse of this trigger signal Trg and the generation of the pulse of the vertical synchronization signal Vsync (that is, a width for adjustment between Vsync and Trg).

The TP controller 30, when detecting a pulse of the trigger signal Trg, starts the screen scanning operation with respect to the drive lines DRL. The driving signal for each drive line DRL can be, for example, a pulse generated when a certain period of time (Wht) elapses after the pulse of the horizontal synchronization signal Hsync. A plurality of pulses are applied as a driving signal, with respect to one drive line DRL. The number of pulses of the driving signal applied to one drive line DRL is controlled by the TP controller 30.

The driving signals Dr(1) to Dr(P) are applied sequentially to the drive lines DRL(1) to DRL(P), i.e., all of the drive lines in the screen, respectively, and then, the operation for scanning one screen ends. Here, time for scanning one screen with respect to the drive lines DRL(1) to DRL(P) is controlled by the TP controller 30 so as to be shorter than time for scanning one screen with respect to the gate lines G(1) to G(N). The TP controller 30 can control the time for scanning one screen with respect to the drive lines DRL(1) to DRL(P) by, for example, controlling the number of pulses of the driving signal applied to each drive line DRL, the frequency of the same, or the like.

In the present embodiment, as one example, the time for scanning one screen with respect to the drive lines DRL(1) to DRL(P) can be equal to, or less than, half of the time for scanning one screen with respect to the gate lines G(1) to G(N). This makes it possible to ensure sufficient time between a current one of the screen scanning operation with respect to the drive lines DRL(1) to DRL(P), and the next one of the screen scanning operation with respect to the drive lines DRL(1) to DRL(P). This makes it possible to ensure sufficient time for a detection signal processing operation (for example, computing a detection position using a detection signal) by the TP controller 30.

As described above, the start of the screen scanning operation with respect to the gate lines G in the display device 2, that is, the start of writing to the screen, and the start of the screen scanning operation in the touch panel 20, do not coincide with each other, whereby a location where the writing to the screen in the display device 2 is performed, and a portion of the touch panel 20 that is driven, can be made different. This makes it possible to suppress the mutual interference.

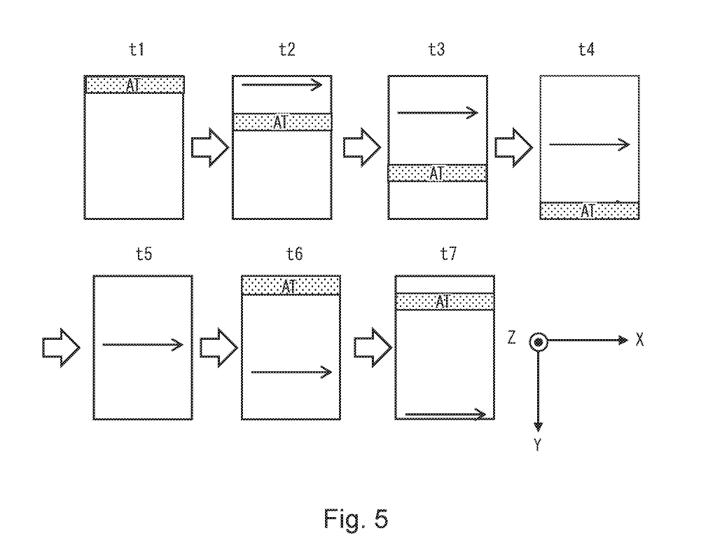

FIG. 5 illustrates exemplary transition of the location where the gate line G is driven and the location where the drive line DRL is driven, on the screen. FIG. 5 illustrates an exemplary case where the display device 2 and the touch panel 20 are driven with the signals illustrated in FIG. 4. In FIG. 5, the rectangle indicates the screen, the arrow indicates the location in the screen where the gate line G is driven, that is, a location where the writing of an image is performed, and the dot pattern indicates the location (AT) where the drive line DRL is driven.

In the example illustrated in FIG. 5, at time t1, at the point in time when the screen scanning operation with respect to the drive lines DRL starts, the screen scanning operation with respect to the gate lines G has not started yet. After the start of the screen scanning operation with respect to the drive lines DRL, as the scanning is going on, the location where the drive line DRL is driven moves in the downward direction on the screen (in the positive direction in the Y direction). At time t2 when the screen scanning operation with respect to the gate lines G starts, the location where the drive line DRL is driven is lower than the location where the gate line G is driven. In other words, at time t2, the driven location in the screen scanning operation with respect to the drive lines DRL is different from the driven location in the screen scanning operation with respect to the gate lines G.

The screen scanning rate in the Y direction with respect to the drive lines DRL is higher than the scanning rate with respect to the gate lines G. Therefore, during a period from time t2 to time t5 while the location where the drive line DRL is driven shifts and reaches the lower end of the screen, whereby the screen scanning operation with respect to the drive lines DRL ends (time t2 to time t5), the location where the gate line G is driven never catches up with the location where the drive line DRL is driven. In other words, before a current one of the screen scanning operation with respect to the gate lines G ends, a current one of the screen scanning operation with respect to the drive lines DRL ends, and a next one of the screen scanning operation with respect to the drive lines DRL starts (time t6). When the screen scanning operation with respect to the gate lines G ends (time t7), the next one of the screen scanning operation with respect to the drive lines DRL has started already.

In this way, during a period while the screen scanning operation with respect to the gate lines G and the screen scanning operation with respect to the drive lines DRL are performed simultaneously, the display device 2 and the touch panel 20 are controlled in such a manner that the location where the gate line G is driven and the location where the drive line DRL is driven should not overlap. This makes it possible to suppress the mutual interference.

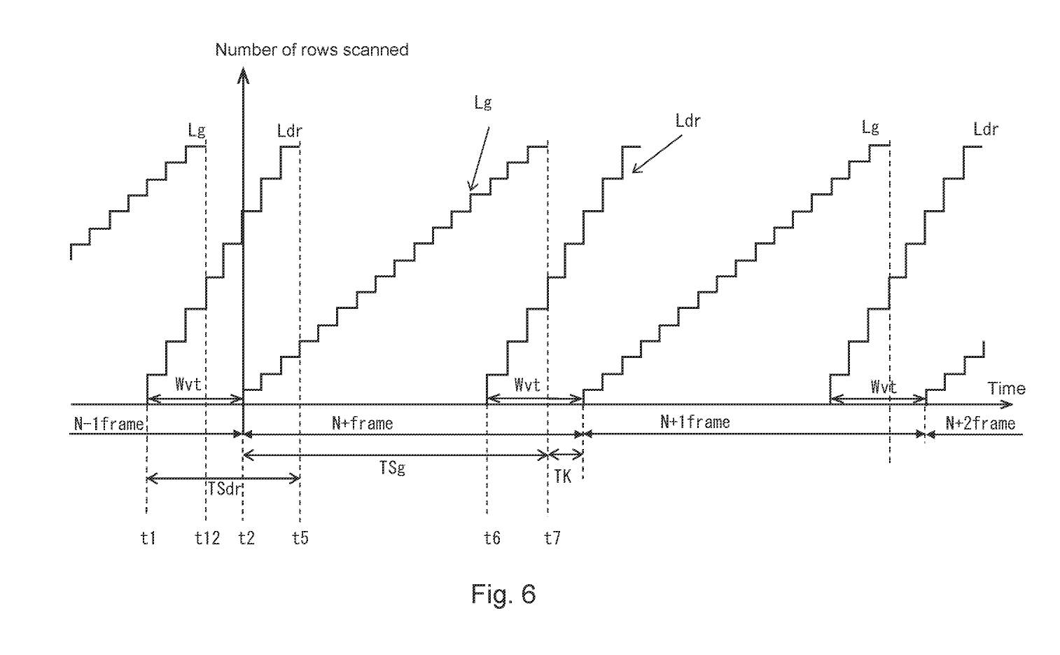

FIG. 6 is a graph for explaining the relationship between the progress of the scanning of the gate lines G and that of the drive lines DRL. In the graph of FIG. 6, the vertical axis represents the number of rows of pixels scanned (the number of lines), and the horizontal axis represents time. FIG. 6 illustrates an exemplary case where the display device 2 and the touch panel 20 are driven with the signals illustrated in FIG. 4. In FIG. 6, the line Ldr indicates the degree of progress of the screen scanning operation with respect to the drive lines DRL in the Y direction, and the line Lg indicates the degree of progress of the screen scanning operation with respect to the gate lines G in the Y direction. The degree of progress of the scanning operation is indicated by the number of rows of the pixels.

As illustrated in FIG. 6, at time t1, the screen scanning operation with respect to the drive lines DRL starts a period Wvt earlier than the start (time t2) of the screen scanning operation with respect to the gate lines G. Then, the screen scanning operation with respect to the drive lines DRL ends after the screen scanning operation with respect to the gate lines G starts and before the same ends (time t5). Further, the time t1 when the screen scanning operation with respect to the drive lines DRL starts is before the time t2 when the screen scanning operation with respect to the gate lines G starts, and before the time t12 when a preceding one of the screen scanning operation with respect to the gate lines G ends.

In this way, in the present example, the screen scanning operation with respect to the drive lines DRL is performed, extending over two consecutive periods of the screen scanning operations with respect to the gate lines G. More specifically, the screen scanning operation with respect to the drive lines DRL starts before the former one of the two consecutive screen scanning operations with respect to the gate lines G ends, and the screen scanning operation with respect to the drive lines DRL ends after the latter screen scanning operation with respect to the gate lines G starts.

Here, time TSdr required for scanning the drive lines DRL over all of rows of the pixels in the screen is shorter than time TSg required for scanning the gate lines G over all of rows of the pixels in the screen. In other words, the scanning rate in the Y direction with respect to the drive lines DRL is higher than the writing rate in the Y direction with respect to the gate lines G. The lines Ldr, therefore, never cross with the lines Lg. The drive line DRL and the gate line G corresponding to the same row are never driven at the same time.

In the example illustrated in FIG. 6, the cycle of the screen scanning operation with respect to the drive lines DRL is the same as the cycle of the screen scanning operation with respect to the gate lines G. In both of the screen scanning operations, one frame period is the cycle thereof. This makes it possible to further surely suppress the interference between the driving of the drive lines DRL and the driving of the gate lines G. The cycle of the screen scanning operation with respect to the drive lines DRL and the cycle of the screen scanning operation with respect to the gate lines G do not have to be the same. For example, the cycle of the screen scanning operation with respect to the drive lines DRL may be shorter than the cycle of the screen scanning operation with respect to the gate lines G, whereby the response performance of the detection can be enhanced.

In the example illustrated in FIG. 6, a period while the scanning of the gate lines G is performed, and a pausing period while the gate lines G and the data lines S are not driven (vertical flyback period), are included in one frame period. In the present example, since the driving of the gate lines G and the driving of the drive lines DRL can be simultaneously carried out, the period for the driving of the drive lines DRL is not limited to the pausing period. In one frame period, therefore, a long period can be ensured for the screen scanning operation with respect to the gate lines G, that is, the pixel writing operation, while the pausing period can be shortened. Or alternatively, the entirety of one frame period may be assigned to the scanning period of the gate lines G, that is, the writing period, so that no pausing period is provided. This makes it possible to easily achieve both of the display image of higher resolution and the improvement of the detection performance, while suppressing the interference.

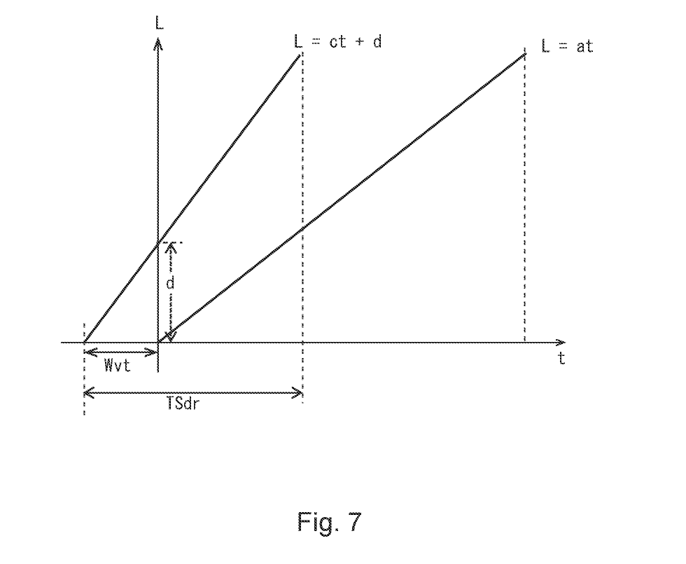

FIG. 7 is a graph for explaining the difference between the screen scanning operation with respect to the gate lines G and that with respect to the drive lines DRL regarding the rate and the starting time. In the graph of FIG. 7, the vertical axis represents the number of rows of pixels scanned (the number of lines), and the horizontal axis represents time. Here, as one example, the scanning rate c with respect to the drive lines DRL and the scanning rate a with respect to the gate lines G are set to the numbers of rows of pixels scanned per unit time. In the screen scanning operation, the number of rows of pixels scanned is given as “L”, and time that has elapsed since the start of the screen scanning operation with respect to the gate lines G is given as “t”. Further, the number of rows of pixels corresponding to an area of the drive lines DRL that have been already scanned as of the start of the scanning operation with respect to the gate lines G is given as “d”.

In this case, as illustrated in FIG. 7, the number L of rows scanned in the screen scanning operation with respect to the gate lines G can be expressed as L=at, and the number L of rows scanned in the screen scanning operation with respect to the drive lines DRL can be expressed as L=ct+d. In order that the driving of the gate lines G and the driving of the drive lines DRL should not interfere with each other, a, c, and d may be set so that the straight line expressing L=at and the straight line expressing L=ct+d should not cross each other. For example, by setting a≤C and d≥0, the driving interference can be suppressed more surely. This is equivalent to the control of the driving signals for the drive lines DRL and the gate lines G in the following manner: the screen scanning operation with respect to the drive lines DRL starts before the screen scanning operation with respect to the gate lines G, and the scanning rate c with respect to the drive lines DRL is higher than the scanning rate a with respect to the gate lines G.

Further, the difference Wvt between the time when the scanning operation with respect to the gate line G starts and the time when the scanning operation with respect to the drive lines DRL starts can be determined from the viewpoint of, when the scanning operation with respect to the gate lines G starts, ensuring a sufficient distance between the gate line G selected first in the scanning operation, and the location where the drive line DRL is driven at that time. For example, Wvt can be set to such a degree that no interference should occur between the location where the gate line G is driven when the scanning operation with respect to the gate lines G starts, that is, the gate line G(1) connected to the pixels in the first row, and the location where the drive line DRL is driven at the same time, that is, the drive line DRL corresponding to the pixels in the d'th row. For example, Wvt can be set to about 0.3 to 0.6 time the time TSdr required for the screen scanning operation with respect to the drive lines DRL.

### Modification Example of Operation of Detection Device

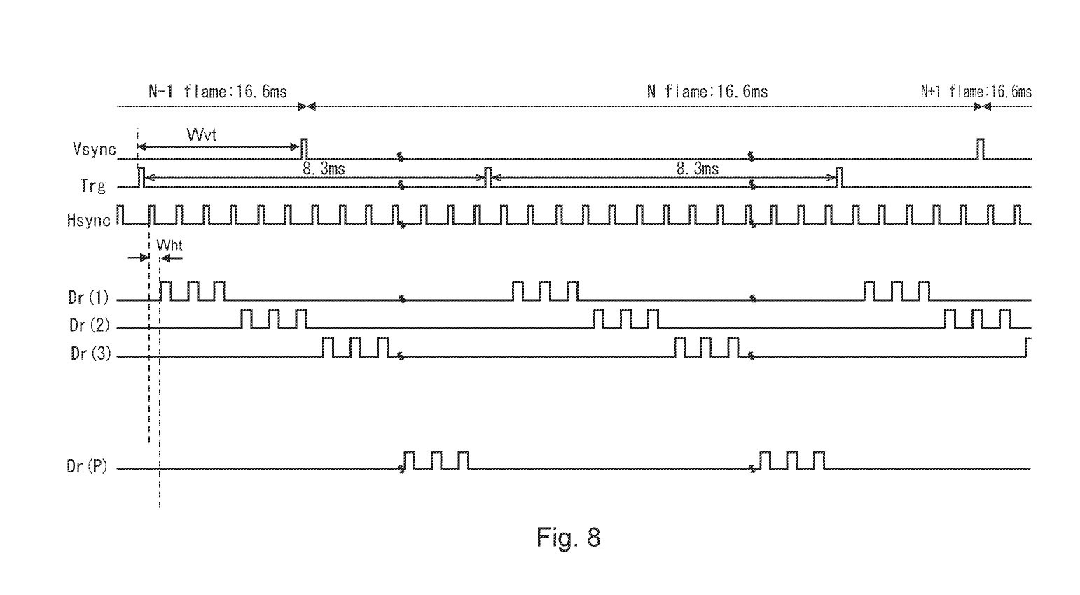

FIG. 8 illustrates modification examples of the waveforms of the driving signals of the display device 2 and the detection device 3. In the example illustrated in FIG. 8, the cycle of the pulse of the trigger signal Trg (8.3 ms) is half of the cycle of the pulse of the vertical synchronization signal Vsync (16.6 ms). This causes the cycle of the screen scanning operation with respect to the drive lines DRL to be half of the cycle of the screen scanning operation with respect to the gate lines G. In other words, the rate of the screen scanning operation for detecting an object on the touch panel 20 (120 Hz) is twice the rate of update (refresh rate) of display of the screen in the display device 2 (60 Hz).

The trigger signal Trg includes a first pulse that is generated at a point in time a certain period (Wvt) earlier than the pulse of the vertical synchronization signal Vsync, and a second pulse that is generated next to the first pulse. The period between the first pulse and the second pulse is half of the cycle of the pulse of the vertical synchronization signal Vsync. This period between the first pulse and the second pulse is the cycle of the trigger signal Trg. In the present example, the first pulse is generated at the same cycle as that of the vertical synchronization signal Vsync.

The TP controller 30 can determine the period Wvt from the generation of the pulse of the trigger signal Trg to the generation of the pulse of the vertical synchronization signal Vsync, and the cycle of the trigger signal Trg, based on values preliminarily recorded in a register or the like.

The TP controller 30, when detecting the pulse of the trigger signal Trg, starts the screen scanning operation with respect to the drive lines DRL. More specifically, at a timing corresponding to the pulse of the horizontal synchronization signal Hsync that is generated after the pulse of the trigger signal Trg is detected, the TP controller 30 applies the pulse of the driving signal to the drive line DRL.

After the driving signals Dr(1) to Dr(P) are sequentially applied to all of the drive lines DRL(1) to DRL(P) in the screen, respectively, the operation of scanning one screen ends. Here, the time required for scanning the drive lines DRL(1) to DRL(P) in one screen is controlled by the TP controller 30 so as to be shorter than the cycle of the trigger signal Trg. As one example, the time required for an operation of scanning one screen with respect to the drive lines DRL(1) to DRL(P) can be equal to, or less than, half of the time required for scanning one screen with respect to the gate lines G(1) to G(N).

In the operation illustrated in FIG. 8, the screen scanning operation with respect to the drive lines DRL can be carried out at a rate twice the rate of the screen scanning operation with respect to the gate lines G, simultaneously with the screen scanning operation with respect to the gate lines G. In these screen scanning operations simultaneously executed, the location where the writing to the screen is carried out by the display device 2, that is, the location where the gate line G is driven, and the location on the touch panel 20 where the drive line DRL is driven are always different. This makes it possible to suppress the mutual interference.

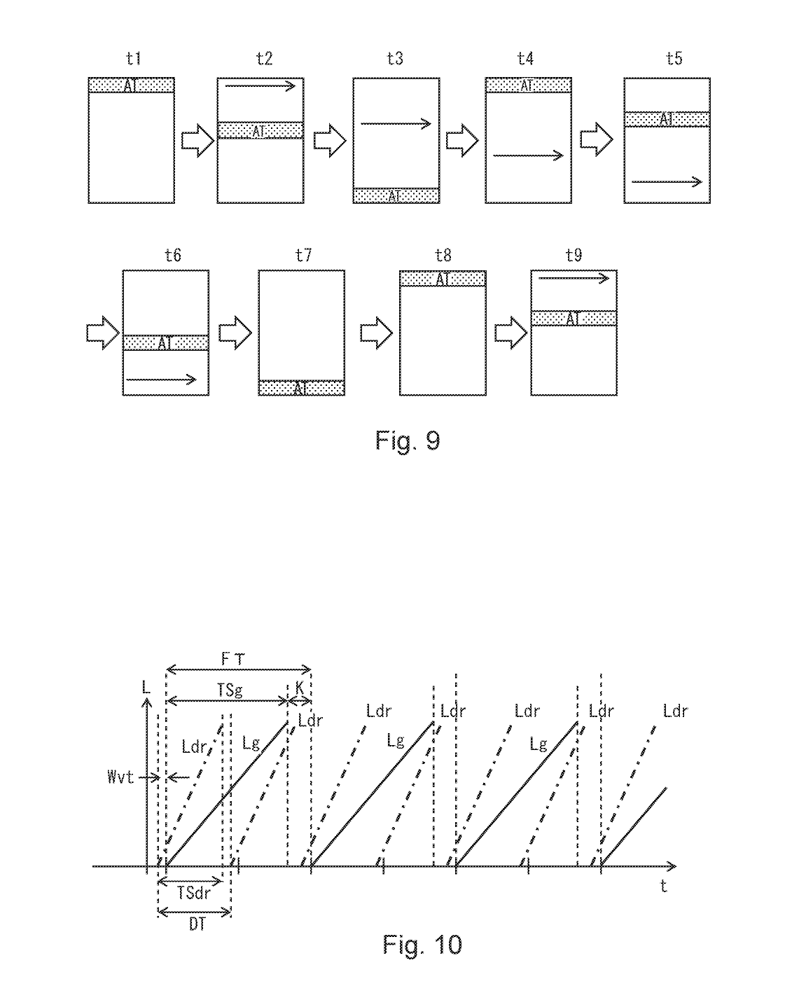

FIG. 9 illustrates exemplary transition of the location where the gate line G is driven and the location where the drive line DRL is driven, on the screen. FIG. 9 illustrates an exemplary case where the display device 2 and the touch panel 20 are driven with the signals illustrated in FIG. 8. In FIG. 9, the rectangle indicates the screen, the arrow indicates the location in the screen where the gate line G is driven, that is, a location where the writing of an image is performed, and the dot pattern indicates the location (AT) where the drive line DRL is driven.

In the example illustrated in FIG. 9, at time t1, at the point in time when the screen scanning operation with respect to the drive lines DRL starts, the screen scanning operation with respect to the gate lines G has not started yet. After the start of the screen scanning operation with respect to the drive lines DRL, as the scanning is going on, the location where the drive line DRL is driven moves in the downward direction on the screen (in the positive direction in the Y direction). At time t2 when the screen scanning operation with respect to the gate lines G starts, the location where the drive line DRL is driven is lower than the location where the gate line G is driven. The rate in the Y direction of the screen scanning operation with respect to the drive lines DRL is higher than the rate of the scanning operation with respect to the gate lines G. Therefore, during a period until the location where the drive line DRL is driven reaches the lower end of the screen, whereby the screen scanning operation with respect to the drive lines DRL ends, that is, during the period from time t2 to time t3, the location where the gate line G is driven never catches up with the location where the drive line DRL is driven. Further, at time t4, before a current one of the screen scanning operation with respect to the gate lines G ends, a next one of the screen scanning operation with respect to the drive lines DRL starts.

At time t6 when the location where the gate line G is driven reaches the lower end of the screen, the location where the drive line DRL is driven reaches the middle of the screen. During a period from when a current one of the screen scanning operation with respect to the gate lines G ends until when a next one of the screen scanning operation with respect to the gate lines G starts, a current one of the screen scanning operation with respect to the drive lines DRL ends also (time t7), and further, a next one of the screen scanning operation with respect to the drive lines DRL starts (time t8). At time t9 when the next one of the screen scanning operation with respect to the gate lines G starts, the location where the drive line DRL is driven is lower than the location where the gate line G is driven.

In this way, the screen scanning operation with respect to the gate lines G, and the screen scanning operation with respect to the drive lines DRL, which is carried out at a doubled rate, are carried out simultaneously, and during this period, the location where the gate line G is driven and the location where the drive line DRL is driven do not overlap each other. This makes it possible to achieve both of the detection operation at a higher rate, and the update of the screen with high-resolution images, while suppressing the interference between the gate lines G and the drive lines DRL.

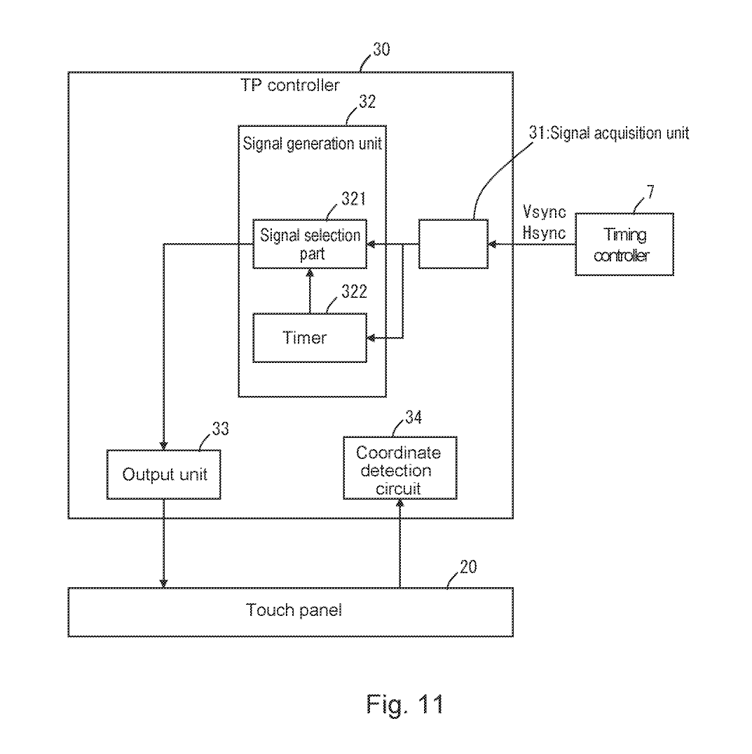

FIG. 10 is a graph for explaining the relationship between the progress of the scanning of the gate lines G and that of the drive lines DRL. In the graph of FIG. 10, the vertical axis represents the number of rows of pixels scanned (the number of lines), and the horizontal axis represents time t. FIG. 10 illustrates an exemplary case where the display device 2 and the touch panel 20 are driven with the signals illustrated in FIG. 8. In FIG. 10, the line Ldr indicates the degree of progress of the screen scanning operation with respect to the drive lines DRL in the Y direction, and the line Lg indicates the degree of progress of the screen scanning operation with respect to the gate lines G in the Y direction. The degree of progress of the scanning operation is indicated by the number L of rows of the pixels.

As illustrated in FIG. 10, the screen scanning operation with respect to the drive lines DRL starts a period Wvt earlier than the start of the screen scanning operation with respect to the gate lines G. Then, after the current one of the screen scanning operation with respect to the gate lines G starts and before the same ends, the current one of the screen scanning operation with respect to the drive lines DRL ends, and a next one of the screen scanning operation with respect to the drive lines DRL starts. Here, time TSdr required for scanning the drive lines DRL over all of rows of the pixels in the screen is equal to, or less than, half of time TSg required for scanning the gate lines G over all of rows of the pixels in the screen. In other words, the rate for scanning the drive lines DRL in the Y direction is equal to, or higher than, twice the rate for writing with respect to the gate lines G in the Y direction.

During a period from when the current one of the screen scanning operation with respect to the gate lines G ends until a next one of the screen scanning operation with respect to the gate lines G starts, that is, during the vertical flyback period (pausing period) K, the current one of the screen scanning operation with respect to the drive lines DRL ends and a next one of the same starts. Here, the cycle DT of the screen scanning operation with respect to the drive lines DRL is half of the cycle of the screen scanning operation with respect to the gate lines G, that is, half of one frame period FT (DT=FT/2). During one frame period FT, therefore, one screen scanning operation with respect to the gate lines G, and two screen scanning operations with respect to the drive lines DRL are carried out.

In the example illustrated in FIG. 10, the line Ldr and the line Lg do not cross with each other. In other words, in the screen scanning operation, the row of pixels corresponding to the drive line DRL driven, and the row of pixels corresponding to the gate line G driven simultaneously, never overlap. It is therefore less likely that the driving of the drive lines DRL and the driving of the gate lines G would interfere with each other.

It should be noted that the cycle DT of the screen scanning operation with respect to the drive lines DRL is not limited to half of one frame period FT. For example, the cycle DT of the screen scanning operation with respect to the drive lines DRL can be a quarter, one third, two thirds, three quarters, or the like, of one frame period FT. The cycle DT of the screen scanning operation with respect to the drive lines DRL can be controlled by, for example, adjusting the cycle of the trigger signal Trg generated by the TP controller 30.

### Exemplary Configuration of TP Controller

The following description describes an exemplary configuration of the TP controller 30 that controls the touch panel 20 so as to realize the above-described operation. FIG. 11 is a functional block diagram illustrating an exemplary configuration of the TP controller 30.

In the example illustrated in FIG. 11, the TP controller 30 includes a signal acquisition unit 31, a signal generation unit 32, an output unit 33, and a coordinate detection circuit 34. The signal generation unit 32 includes a signal selection part 321 and a timer 322.

The signal acquisition unit 31 receives a synchronization signal used for controlling the timing for updating the display of the screen, from the timing controller 7. The signal acquisition unit 31 includes, for example, a port for inputting a signal. The synchronization signal includes, for example, the vertical synchronization signal Vsync and the horizontal synchronization signal Hsync.

The signal generation unit 32 generates a signal for controlling the timing of the detection scanning operation of the screen, based on the synchronization signal received by the signal acquisition unit 31. In the detection scanning operation, the driving signal is applied to the plurality of drive lines DRL sequentially. This is a scanning operation for detecting contact or approach of an object with respect to the touch panel 20.

The signal generation unit 32 generates a signal for such control that during a period from the start of the detection scanning operation with respect to the screen until the end of the same, the updating of the display on the screen starts, and a scanning time for one screen of the detection scanning operation is equal to, or shorter than, an update time for display of one screen.

The output unit 33 outputs a signal generated by the signal generation unit 32 or a driving signal based on this signal, to the touch panel 20. The output unit 33 applies a driving signal to each drive line DRL, according to the signal generated by the signal generation unit 32.

The coordinate detection circuit 34 calculates coordinates indicating a position on the screen that an object is in contact with or approaches (a position on the touch panel 20), based on a detection signal detected by the detection lines SNL of the touch panel 20.

In the signal generation unit 32, the timer 322 generates an internal signal, based on the synchronization signal received by the signal acquisition unit 31, and outputs the internal signal to the signal selection part 321. The signal selection part 321 selects at least one signal from the internal generation signal generated by the timer 322 and the synchronization signal received by the signal acquisition unit 31, and transmits the selected signal to the output unit 33.

The timer 322 can generate a pulse when a preliminarily set period of time elapses from the rising or the falling of the pulse of the input signal. This makes it possible to generate, for example, a signal that includes a pulse at a point in time that is advanced/delayed for a certain period of time (for example, Wvt, Wht in FIG. 1, FIG. 8, or the like) from the pulse of the vertical synchronization signal Vsync. Further, a signal can be generated that includes pulses generated at a predetermined cycle, for example, like the cycle of the pulses of Trg or Dr(1) to Dr(p) illustrated in FIG. 1, FIG. 8.

For this configuration, the timer 322 can include an edge detection circuit that detects an edge (a rising edge or a falling edge) of a pulse of an input signal, a clock generation circuit that generates a clock signal having a certain frequency, a counter that counts the number of clock pulses of a clock signal after the edge detection, and an internal signal generation circuit that generates a pulse according to the count by the counter (all are not illustrated).

The internal signal generation circuit compares the count of the counter with a value preliminarily set in a register or the like, and when the count reaches the preliminarily set value, the internal signal generation circuit generates a pulse. In this case, Wvt, Wht in FIG. 1, FIG. 8, or alternatively, pulse cycles of Trg or Trg or Dr(1) to Dr(p), or the like can be set preliminarily.

The timer 322 can generate, as an internal signal, for example, the trigger signal Trg, a pulse signal as a base for the driving signals Dr(1) to Dr(P), which are illustrated in FIG. 1, FIG. 8, or a driving synchronization signal for controlling a time for driving one drive line DRL, or the like.

The signal selection part 321 selects at least one signal to be supplied to the output unit 33, from the signals generated by the timer 322. For example, the signal selection part 321 can select the driving signals Dr(1) to Dr(p) for the respective drive lines DRL, which are generated by the timer 322. Or alternatively, the signal selection part 321 can select the pulse signal as a base for the driving signals Dr(1) to Dr(p), and the trigger signal Trg indicating the driving timing. Further, the signal selection part 321 may select the driving synchronization signal, which indicates the driving timing of each drive line DRL. The output unit 33 applies a driving signal to the drive lines DRL(1) to DRL(P), according to the signal output from the signal selection part 321,

The configuration of the TP controller 30 is not limited to the example illustrated in FIG. 11. For example, the coordinate detection circuit 34 can be arranged outside the TP controller 30. Further, the signal received by the signal acquisition unit 31 is not limited to the vertical synchronization signal Vsync and the horizontal synchronization signal Hsync; in place of these signals, or in addition to these signals, the signal acquisition unit 31 may receive another signal for controlling the update timing of the display screen. For example, the signal acquisition unit 31 can receive a general-purpose input/output (GPIO) from the timing controller 7. Still further, the signal acquisition unit 31 may receive a synchronization signal, not from the timing controller 7, but from the system-side controller 10.

The above description describes the embodiment of the present invention, but the present invention is not limited to the above-described embodiment. For example, the embodiment is described with reference to an exemplary driving operation in which a pulse signal is input to each of the drive lines DRL sequentially one by one, but the driving operation may be such that a pulse signal is input simultaneously to two or more of the drive lines DRL. Further, the above-described embodiment is an example of a mutual capacitance touch panel, but the touch panel may be a self-capacitance touch panel.

Further, the display device 2 is not limited to the liquid crystal display device as described above. The display device 2 may be, for example, an organic EL display, a plasma display, or a display in which electrophoresis or MEMS is used.

### DESCRIPTION OF REFERENCE NUMERALS

1: sensor-equipped display device
2: display device
3: detection device
4: scanning line driving circuit (exemplary scanning driving unit)
5: data line driving circuit (exemplary data driving unit)
8: TFT (exemplary switching element)
9: pixel electrode
11: common electrode
20: touch panel
30: TP controller (exemplary detection control unit)
G: gate line (exemplary display scanning line)
S: data line
DRL: drive line (exemplary detection scanning line)
SNL: detection line

1. A sensor-equipped display device comprising a screen that displays an image, and a sensor that detects contact or approach of an object with respect to the screen, the sensor-equipped display device comprising:
a plurality of display scanning lines that are arrayed in a first direction,
a plurality of data lines that are arrayed in a second direction that is different from the first direction;
a plurality of switching elements that are provided in correspondence to points of intersection between the display scanning lines and the data lines, respectively;
a plurality of pixel electrodes that are connected to the switching elements, respectively;
a scanning driving unit that repeats a screen scanning operation with respect to the display scanning lines, the screen scanning operation with respect to the display scanning lines being an operation of selecting the display scanning lines sequentially in the first direction throughout the screen;
a data driving unit that outputs a signal to the data lines in synchronization with the scanning of the display scanning lines by the scanning driving unit, thereby applying, to the pixel electrodes, voltages corresponding to gray levels to be displayed, respectively;
a plurality of detection scanning lines that are arrayed in the first direction;
a plurality of detection lines that are arrayed in the second direction; and
a detection control unit that repeats a screen scanning operation with respect to the detection scanning lines, the screen scanning operation with respect to the detection scanning lines being an operation of driving the detection scanning lines sequentially in the first direction throughout the screen, thereby detecting signals of the detection lines in synchronization with the driving of the detection scanning lines, respectively,
wherein, between start of a current one of the screen scanning operation with respect to the detection scanning lines and end of the same, a current one of the screen scanning operation with respect to the display scanning lines starts, and time for scanning one screen with respect to the detection scanning lines is equal to, or shorter than, time for scanning one screen with respect to the display scanning lines.

2. The sensor-equipped display device according to claim 1,
wherein the start of the current one of the screen scanning operation with respect to the detection scanning lines is before the start of the current one of the screen scanning operation with respect to the display scanning lines, and before end of a preceding one of the screen scanning operation with respect to the display scanning lines.

3. The sensor-equipped display device according to claim 1,
Wherein the time for scanning one screen with respect to the detection scanning lines is equal to, or less than, half of the time for scanning one screen with respect to the display scanning lines.

4. The sensor-equipped display device according to claim 1,
wherein a cycle of the screen scanning operation with respect to the detection scanning lines is different from a cycle of the screen scanning operation with respect to the display scanning lines.

5. The sensor-equipped display device according to claim 4,
wherein the cycle of the screen scanning operation with respect to the detection scanning lines is half of the cycle of the screen scanning operation with respect to the display scanning lines, and
in a period from end of the current one the screen scanning operation with respect to the display scanning lines until start of a next one of the screen scanning operation with respect to the display scanning lines, the current one of the screen scanning operation with respect to the detection scanning lines ends, and a next one of the screen scanning operation with respect to the detection scanning lines starts.

6. The sensor-equipped display device according to claim 1,
wherein the detection control unit starts the screen scanning operation with respect to the detection scanning lines, according to a signal generated based on a synchronization signal for controlling a timing of the screen scanning operation with respect to the display scanning lines by the scanning driving unit.

7. The sensor-equipped display device according to claim 6,
wherein the detection control unit controls a timing for starting the screen scanning operation with respect to the detection scanning line, based on the synchronization signal for controlling a timing for starting the screen scanning operation with respect to the display scanning lines by the scanning diving unit, and
the detection control unit controls respective timings for driving the detection scanning lines, based on a horizontal synchronization signal for controlling respective timings for driving the display scanning lines.

8. The sensor-equipped display device according to claim 1, further comprising:
a first substrate on which the display scanning lines, the data lines, and the switching elements are arranged;
a second substrate provided so as to be opposed to the first substrate; and
a common electrode provided so as to be opposed to the pixel electrodes,
wherein the detection scanning lines and the detection lines are arranged on at least one of the first substrate and the second substrate, and are provided independently from the common electrode.

9. A control device that controls electronic equipment that includes: a screen having a plurality of pixels; and a sensor that detects contact or approach of an object with respect to the screen, the control device comprising:
a signal acquisition unit that receives a synchronization signal for controlling a timing for starting update of display on the screen;
a signal generation unit that generates a signal for controlling a timing of a detection scanning operation with respect to the screen for detecting contact or approach of the object, based on the synchronization signal; and
an output unit that outputs the signal generated by the signal generation unit, or a diving signal for the sensor based on the signal generated by the signal generation unit,
wherein the signal generation unit generates the signal so that the update of display on the screen starts between start of the detection scanning operation with respect to the screen and end of the same, and a scanning time for one screen of the detection scanning operation is equal to or shorter than a display update time for one screen.

10. A control method for controlling electronic equipment that includes: a screen having a plurality of pixels; and a sensor that detects contact or approach of an object with respect to the screen, the control method comprising:
a display controlling step of controlling timing for starting update of display on the screen, based on a synchronization signal; and
a detection controlling step of controlling a detection scanning operation with respect to the screen for detecting the contact or approach of the object, based on the synchronization signal for controlling the timing for starting the update of display on the screen,
wherein, in the detection controlling step, the detection scanning operation is controlled so that the update of display on the screen starts between start of the detection scanning operation with respect to the screen and end of the same, and a scanning time for one screen of the detection scanning operation is equal to or shorter than a display update time for one screen.
